(19) United States
(12) Patent Application Publication
(10) Pub. No.: US 2024/0317102 A1
(43) Pub. Date: Sep. 26, 2024

(54) CONTROL APPARATUS

(71) Applicant: HONDA MOTOR CO., LTD., Tokyo (JP)

(72) Inventor: Daisuke INOUE, Tokyo (JP)

(21) Appl. No.: 18/590,964

(22) Filed: Feb. 29, 2024

(30) Foreign Application Priority Data
Mar. 23, 2023 (JP) 2023-047194

(51) Int. Cl. B60L 53/63; B60L 53/62; H02J 13/00

(52) U.S. Cl. CPC B60L 53/63; B60L 53/62; H02J 13/00004

(57) ABSTRACT

Provided is a control apparatus that can accurately predict charging and discharging trends for a power storage system for a vehicle, irrespective of the presence or absence of usage information for the vehicle. A control apparatus is provided with: an obtainment unit that, for each of a plurality of power storage systems respectively mounted to a plurality of vehicles, obtains a usage history of a mobile terminal which corresponds to an external power storage apparatus associated with the power storage system; and a selection unit that estimates trends for charging and discharging between each power storage system and an electric power network based on the usage history and, in accordance with an estimation result, selects from the plurality of power storage systems a power storage system to be subject to charging or discharging from or to the electric power network.

This application is based on and claims the benefit of priority from Japanese Patent Application No. 2023-047194, filed on 23 Mar. 2023, the content of which is incorporated herein by reference.

### BACKGROUND OF THE INVENTION

### Field of the Invention

The present invention pertains to a control apparatus.

### Related Art

In recent years, research and development pertaining to storage batteries that contribute to increasing energy efficiency has been carried out in order to be able to ensure access to sustainable and advanced energy that can be trusted and can be afforded by more people.

For example, a technique for predicting a timing for charging or discharging a storage battery in a vehicle based on a usage situation or the like, and controlling charging and discharging for the storage battery is known (for example, refer to Japanese Unexamined Patent Application, Publication No. 2022-050126).

Japanese Unexamined Patent Application, Publication No. 2022-050126 pertains to a distributed energy resource management apparatus. Japanese Unexamined Patent Application, Publication No. 2022-050126 describes a distributed energy resource management apparatus that is provided with: a prediction unit that predicts an amount of electric power demand and an amount of electric power supply for each unit of time for a consumer who has a storage battery in a vehicle that serves as a distributed energy resource; an input unit that inputs usage information that includes information regarding periods of time in which the vehicle is used; and a plan creation unit that creates a charge-discharge plan for the storage battery based on the amount of electric power demand, the amount of electric power supply, and the usage information.
Patent Document 1: Japanese Unexamined Patent Application, Publication No. 2022-050126

### SUMMARY OF THE INVENTION

In a case of using a power storage system mounted to a vehicle in demand response (DR) control for adjusting supply and demand for an electric power network, it is presupposed that the vehicle is connected to charging/discharging equipment. However, just because an electric automobile has entered a garage provided with charging/discharging equipment does not mean that the vehicle is connected to the charging/discharging equipment. As to whether a vehicle is connected to charging/discharging equipment depends, in the end, on a decision made by a user.

DR control can be accurately executed if it is possible to predict that a vehicle is connected to charging/discharging equipment by monitoring a SOC of a battery mounted to a vehicle or making a prediction based on usage information for the vehicle, as in the known art. However, there are cases where there is no usage information for a vehicle or cases where an amount of usage information that is sufficient to make a prediction is not present.

One object of the present invention is to provide a control apparatus that can accurately predict charging and discharging trends for a power storage system for a vehicle, irrespective of the presence or absence of usage information for the vehicle. By extension, one object is to contribute to improving energy efficiency.

(1) The present invention is a control apparatus including: an obtainer configured to obtain, for each power storage system respectively mounted to a plurality of vehicles, a usage history of an external power storage associated with the power storage; and a selector configured to estimate charging and discharging trends between each power storage and an electric power network based on the usage history of the external power storage and, in accordance with an estimation result, select from among a plurality of the power storages a power storage to be subject to charging or discharging from or to the electric power network.

(2) In the control apparatus according to (1), the external power storage may be a mobile terminal that is owned by a user of the vehicle.

(3) The control apparatus according to (1) may further include a priority level setter configured to set a high priority level for the power storage corresponding to the external power storage in a case where there is a high frequency of charging for the external power storage.

(4) The control apparatus according to (1) may further include a notifier configured to set a high frequency for notifying information pertaining to charging or discharging with respect to the power storage corresponding to the external power storage in a case where there is a low frequency of charging for the external power storage.

(5) In the control apparatus according to (1), the selector may reflect, to the selection of the power storage, a timing for maintenance of a state of charge of the external power storage, as well as an extent to which the state of charge of the external power storage has been maintained.

(6) In the control apparatus according to (1), at a timing when the external power storage is charged within the vehicle, the obtainer may obtain, as the usage history, information that includes at least a charging history.

(7) In the control apparatus according to (6), the obtainer may obtain the usage history at a time of charging using a non-contact charger that is within the vehicle.

(8) In the control apparatus according to (1), the selector may preferentially select the power storage that has a high probability of being connected to a charger/discharger.

(9) In the control apparatus according to (1), in a case where a supply/demand state of the electric power network indicates excess electric power, the selector may preferentially select the power storage belonging to a user indicating a tendency to have a low state of charge based on the usage history.

(10) In the control apparatus according to (1), in a case where a supply/demand state of the electric power network indicates insufficient electric power, the selector may preferentially select, based on the usage history, the power storage that belongs to a user and indicates a trend for a high state of charge.

(11) In the control apparatus according to (1), the selector may generate an allocation proposal that indicates a combination of the power storages selected to be the power storage for carrying out charging or discharging from or to the electric power network, and in the allocation proposal, the power storages may be selected by employing a priority level set based on the charging and discharging trends as a parameter.

(12) In addition, the present invention is a control apparatus including: an obtainer configured to obtain, for each power storage respectively mounted to a plurality of vehicles, a usage history of an external power storage associated with the power storage; and a demand predictor that obtains a demand prediction for an electric power network and reflects, to the demand prediction, charging and discharging trends that are for between the electric power network and the power storage and are estimated based on the usage history of the external power storage.

By virtue of the present invention, it is possible to provide a control apparatus that can accurately predict charging and discharging trends for a power storage for a vehicle, irrespective of the presence or absence of usage information for the vehicle. By extension, it is possible to contribute to improving energy efficiency.

### BRIEF DESCRIPTION OF THE DRAWINGS

FIG. 1 is a schematic view that illustrates a configuration of an electric power system to which is applied a control apparatus according to one embodiment of the present invention;

FIG. 2 is a schematic view that illustrates a functional configuration of a power storage system that is installed in a vehicle;

FIG. 3 is a block view that illustrates an example of a hardware configuration of the control apparatus according to the present embodiment;

FIG. 4 is a block view that illustrates an example of a functional configuration of the control apparatus according to the present embodiment;

FIG. 5 is a flow chart that illustrates an example of a flow of processing for DR control by the control apparatus according to the present embodiment;

FIG. 6 is a graph that illustrates change over time for a SOC regarding a mobile terminal that a user A owns; and

FIG. 7 is a graph that illustrates change over time for a SOC regarding a mobile terminal that a user B owns.

### DETAILED DESCRIPTION OF THE INVENTION

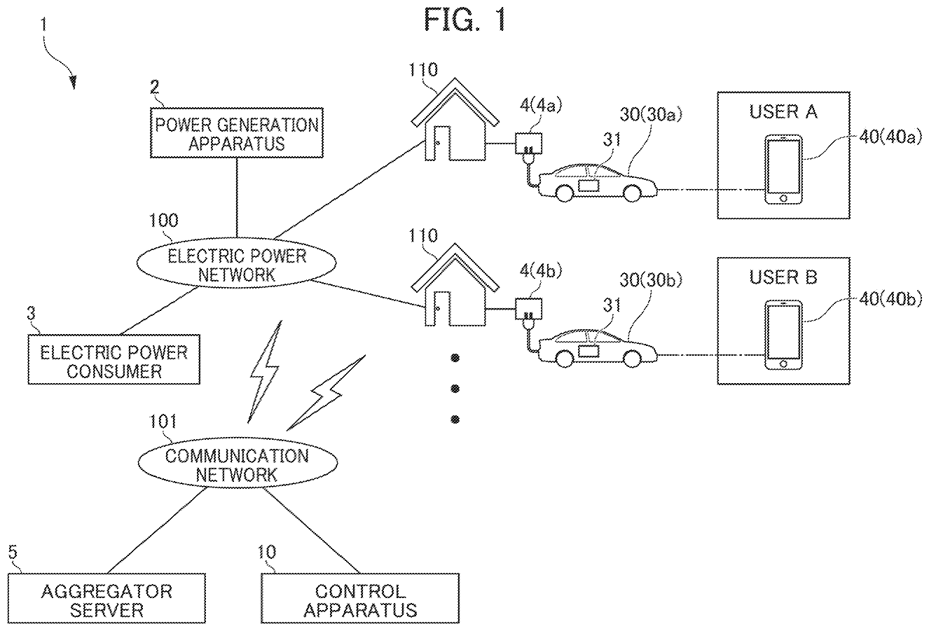

FIG. 1 is a schematic view that illustrates a configuration of an electric power system 1 to which is applied a control apparatus 10 according to one embodiment of the present invention. The electric power system 1 is provided with a power generation apparatus 2, an electric power consumer 3, charging/discharging equipment 4, vehicles 30, mobile terminals 40, an aggregator server 5, and the control apparatus 10.

The power generation apparatus 2 is connected to an electric power network 100 that is an electric power grid or the like. The power generation apparatus 2 is, inter alia, a power plant operated by an electric power company, for example. The electric power consumer 3 and the charging/discharging equipment 4 are connected to the electric power network 100. Electric power generated by the power generation apparatus 2 is supplied to the electric power consumer 3 and the charging/discharging equipment 4 through the electric power network 100.

Each instance of charging/discharging equipment 4 is installed at a building 110 such as a dwelling unit or a facility. The charging/discharging equipment 4 performs charging and discharging with respect to a power storage system 31 mounted to a vehicle 30. The vehicle 30 is an electric automobile, for example. The intended use or type of the vehicle 30 is not limited in particular. The vehicle 30 may be, inter alia, a vehicle owned by an individual, a vehicle used by a business operator for their business, or a shared car.

In a case where electric power is supplied from the power storage system 31 to the charging/discharging equipment 4, the supplied electric power is consumed by an electric power load within the building 110 or is provided to the electric power network 100 via an electric power line installed to the building 110. In a case where the charging/discharging equipment 4 supplies electric power to the power storage system 31, the charging/discharging equipment 4 supplies the power storage system 31 with electric power transmitted from the electric power network 100, or supplies the power storage system 31 with electric power that is produced at the building 110 itself using solar power generation or the like.

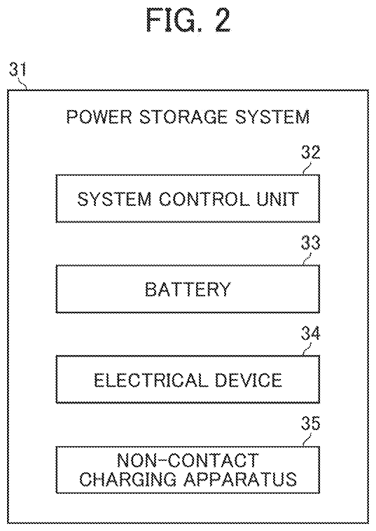

FIG. 2 is a schematic view that illustrates a functional configuration of the power storage system 31 that is installed in a vehicle 30. As illustrated in FIG. 2, the power storage system 31 is provided with a system control unit 32, a battery 33, an electrical device 34, and a non-contact charging apparatus 35. The system control unit 32 is connected to an external device such as the control apparatus 10 in a manner that enables communication. The system control unit 32 is a control device such as an electronic control unit (ECU) that controls, inter alia, charging and discharging for the battery 33 and operation by the electrical device 34. The battery 33 supplies electric power for the vehicle 30 to travel. The electrical device 34 operates in order for the battery 33 to charge and discharge. The electrical device 34 includes, inter alia, electrical components such as a relay, switch, or DC-DC converter, and a communication device such as a telematics control unit (TCU). The non-contact charging apparatus 35 uses electric power from the battery 33 or electric power from an auxiliary battery such as a lead-acid battery to supply electric power to the mobile terminal 40 in a non-contact manner. However, there is no limitation to the non-contact charging apparatus 35 in the present embodiment, and a normal plug connection type charging apparatus may be used in place of the non-contact charging apparatus 35.

Returning to FIG. 1, description is given regarding a mobile terminal 40. The mobile terminal 40 is a computer that is associated with a vehicle 30 or the power storage system 31 in the vehicle 30. The mobile terminal 40 is a portable computer such as a smartphone or a tablet, for example. The mobile terminal 40 is configured to be able to communicate with the control apparatus 10 via a communication network 101. The mobile terminal 40 transmits a usage history, which includes information pertaining to charging of the mobile terminal 40 itself, to the control apparatus 10 via the communication network 101. This usage history may include information that pertains to an attribute such as gender or a company employee.

The information pertaining to charging is data regarding a past usage history, such as a fully charged retention rate for the mobile terminal 40, change over time for a state of charge, and a timing when charging was performed. The mobile terminal 40 transmits information pertaining to charging to the control apparatus 10, by communication that uses a communication cable or by wireless communication. It may be that the mobile terminal 40 transmits information pertaining to charging to the system control unit 32 at a timing when the mobile terminal 40 is supplied with power by the non-contact charging apparatus 35, and the system control unit 32 transmits the information pertaining to charging to the control apparatus 10 via the communication network 101. In addition, it may be that the mobile terminal 40 uses a dedicated program (application) that is installed in the mobile terminal 40 to transmit the information pertaining to charging to the control apparatus 10 via the communication network 101. It may be that the information pertaining to charging is transmitted at a timing when charging is performed, is periodically transmitted, or is transmitted based on a request from the control apparatus 10. In this manner, it is possible to employ various methods of transmitting the information pertaining to charging.

The aggregator server 5 is used by an electric power aggregator that trades electric power in an electric power market. The aggregator server 5 is configured to be able to communicate with the control apparatus 10 via the communication network 101. The aggregator server 5, via the communication network 101, transmits information pertaining to electric power supply and demand to the control apparatus 10, which performs demand response (DR) control for adjusting supply and demand for the electric power network 100. The information pertaining to electric power supply and demand includes a target time period and an adjusted amount of electric power that is based on an amount of demand for electric power, for example.

The control apparatus 10 is an electric power resource management apparatus that, from among a plurality of electric power consumers 3 and vehicles 30, determines a combination that is to be an allocation target for a DR request. The control apparatus 10 obtains the information that pertains to electric power supply and demand and is received from the aggregator server 5. Besides the aggregator server 5, the control apparatus 10 may obtain the information pertaining to electric power supply and demand from the power generation apparatus 2 or an electric power consumer 3. Note that an electric power consumer 3 may include a building 110 in which charging/discharging equipment 4 is installed.

The control apparatus 10 executes DR control in order to provide the electric power network 100 with a required amount of electric power based on the information pertaining to electric power supply and demand, or consume electric power from the electric power network 100. In the DR control, a process for achieving a balance between an amount of power generated by the power generation apparatus 2 and an amount of demand for electric power is performed. On the demand side, in a case where the amount of demand for electric power is greater than the amount of power generated, adjustment is performed in a direction for reducing the amount of demand for electric power and, if the amount of demand for electric power is less than the amount of power generated, adjustment is performed in a direction for increasing the amount of demand for electric power. For example, based on the information pertaining to electric power supply and demand from the aggregator server 5, the control apparatus 10 adjusts electric power from the electric power network 100 by controlling charging and discharging by the battery 33 with respect to the power storage system 31 (battery 33) and the charging/discharging equipment 4.

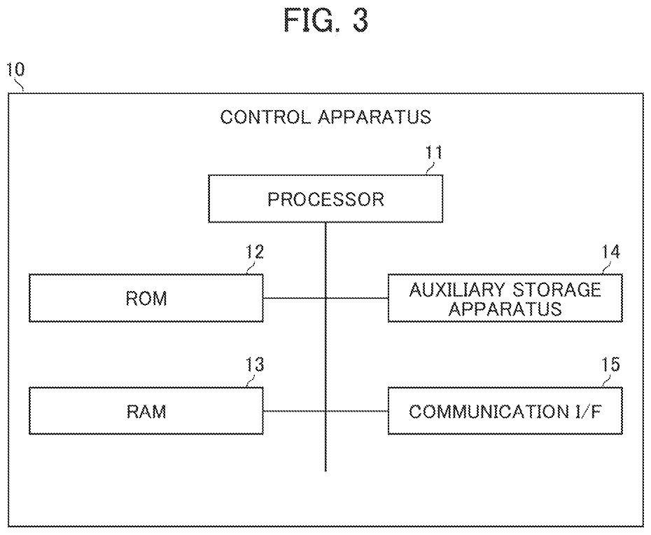

Next, with reference to FIG. 3, description is given regarding a hardware configuration of the control apparatus 10. FIG. 3 is a block view that illustrates an example of a hardware configuration of the control apparatus 10 according to the present embodiment. As illustrated in FIG. 3, the control apparatus 10 is a computer that is provided with a processor 11, a read-only memory (ROM) 12, a random-access memory (RAM) 13, an auxiliary storage apparatus 14, and a communication interface (I/F) 15, and each of these units is connected by a bus or the like.

The processor 11 is a central portion of a computer that performs processing such as control and calculations necessary for operation by the control apparatus 10. The processor 11 performs, inter alia, various calculations and processing. The processor 11 is, for example, a central processing unit (CPU), a micro processing unit (MPU), a system on a chip (SoC), a digital signal processor (DSP), a graphics processing unit (GPU), an application-specific integrated circuit (ASIC), a programmable logic device (PLD), a field-programmable gate array (FPGA), or the like. Alternatively, the processor 11 is a combination of a plurality of these. In addition, the processor 11 may be a combination of combining, inter alia, a hardware accelerator with these.

The processor 11 controls each unit that is for realizing various functionality by the control apparatus 10, based on programs such as firmware, system software, or application software that is stored in the ROM 12, the auxiliary storage apparatus 14, etc. In addition, the processor 11 executes a later-described process based on these programs. Note that some or all of these programs may be incorporated within a circuit in the processor 11.

The ROM 12 and the RAM 13 are main storage apparatuses for the computer that employs the processor 11 as the center thereof. The ROM 12 is a non-volatile memory that is used solely for reading out data. From among the programs described above, firmware or the like is stored in the ROM 12, for example. In addition, the ROM 12 also stores, inter alia, data that the processor 11 uses to perform various processes. The RAM 13 is a memory that is used to read and write data. The RAM 13 is used as, inter alia, a work area for storing data that the processor 11 temporarily uses in order to perform various processes. The RAM 13 is typically a volatile memory.

The auxiliary storage apparatus 14 is, for example, an electrically erasable programmable read-only memory (EEPROM), a hard disk drive (HDD), a flash memory, or the like. From among the programs described above, for example, the auxiliary storage apparatus 14 stores, inter alia, system software and application software. In addition, the auxiliary storage apparatus 14 stores, inter alia, data that the processor 11 uses to perform various processing, data generated by processing by the processor 11, and various setting values. The communication I/F 15 is an interface for communicating with an external apparatus.

In the present embodiment, description is given regarding an example in which the control apparatus 10 is realized by a single computer, but there is no limitation to this configuration. The control apparatus 10 may be realized by a plurality of computers. At least some functions belonging to the control apparatus 10 may be realized by one or more servers such as a cloud server. In addition, a mechanism belonging to a large-scale distributed ledger can be used, as appropriate.

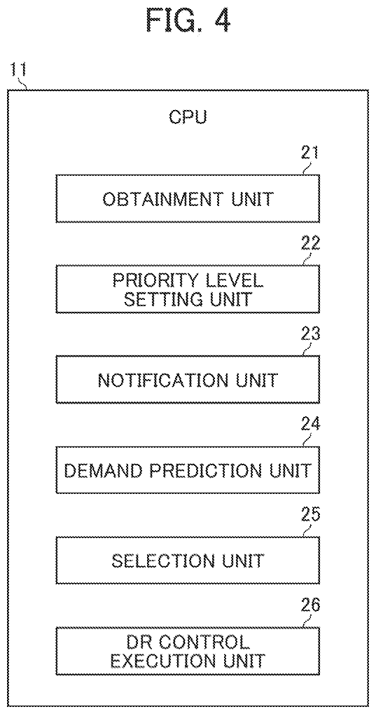

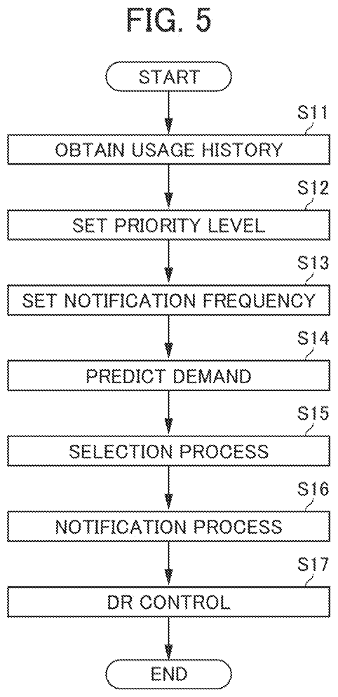

Next, description is given regarding a control function by the control apparatus 10 that is realized by the hardware configuration of the control apparatus 10. FIG. 4 is a block view that illustrates an example of a functional configuration of the control apparatus 10 according to the present embodiment. FIG. 5 is a flow chart that illustrates an example of a flow of processing for DR control by the control apparatus 10 according to the present embodiment. Note that the functional blocks in FIG. 4 and the flow chart in FIG. 5 are purely examples, and the configuration or order of processing can be changed, as appropriate.

As illustrated in FIG. 4, the control apparatus 10 is provided with, as functional units that operate in the processor 11, an obtainment unit 21, a priority level setting unit 22, a notification unit 23, a demand prediction unit 24, a selection unit 25, and a DR control execution unit 26. With reference to FIG. 5, description is given below regarding a configuration for each functional unit.

In step S11, in order to obtain behavioral characteristics pertaining to charging for a user, the obtainment unit 21 obtains information indicating a usage history of the mobile terminal 40 belonging to the user. The information indicating the usage history obtained by the obtainment unit 21 is managed (stored) by being differentiated for each user. For example, from among usage of the mobile terminal 40 which is a smartphone or the like, behavioral characteristics pertaining to charging differ by person, such as with a person who tends to frequently charge, a person who charges when a state of charge (SOC) decreases by approximately a certain level, or a person who does not charge until the capacity becomes almost zero or a value close to zero.

The information indicating the usage history indicates change over time for SOC, which indicates the state of charge in the mobile terminal 40, for example. In the following description, in a case where it is necessary to give a description by differentiating a user A from a user B, description is given by respectively setting the mobile terminal 40, vehicle 30, and charging/discharging equipment 4 owned by the user A as a mobile terminal 40a, a vehicle 30a, and charging/discharging equipment 4a, and respectively setting the mobile terminal 40, vehicle 30, and charging/discharging equipment 4 owned by the user B as a mobile terminal 40b, a vehicle 30b, and charging/discharging equipment 4b.

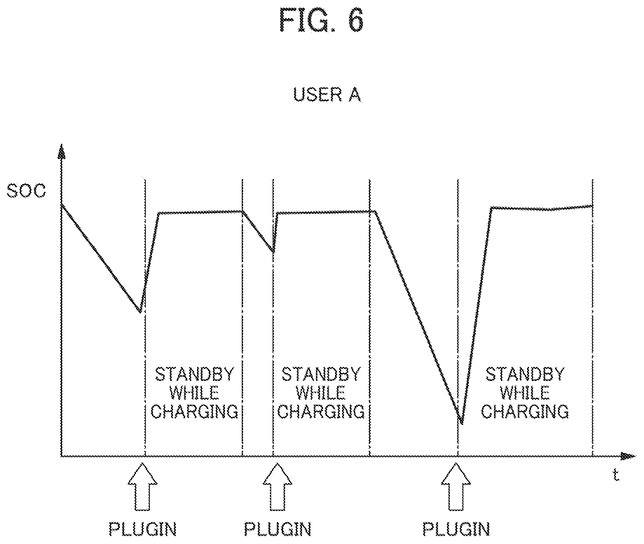

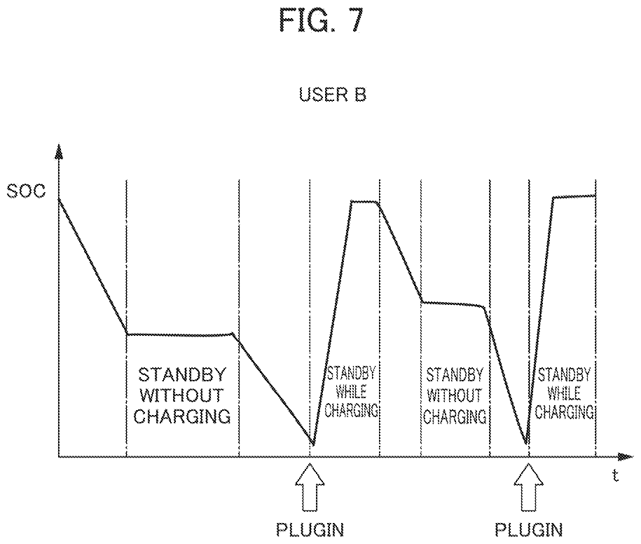

With reference to FIG. 6 and FIG. 7, description is given regarding the information pertaining to usage history that differs for each user. FIG. 6 is a graph that illustrates change over time for the SOC of the mobile terminal 40a that the user A owns. FIG. 7 is a graph that illustrates change over time for the SOC of the mobile terminal 40b that the user B owns. In FIG. 6 and FIG. 7, the arrows are assumed to indicate plugin at which the battery 33 in the power storage system 31 for the vehicle 30 is electrically connected to the charging/discharging equipment 4 and charging starts.

Comparing FIG. 6 and FIG. 7, the user A has behavioral characteristics of periodically charging in accordance with the passage of time, and has a high plugin rate so as to be constantly aiming for fully charged. In contrast, the user B does not charge until SOC decreases by a certain level, and also has time periods of standby without charging. The user B has behavioral characteristics of plugging in and charging when the SOC reaches a threshold.

In order to perform DR control, it is necessary for the charging/discharging equipment 4 to be electrically connected to the power storage system 31 in the vehicle 30. Applying the above-described behavioral characteristics for the mobile terminal 40 to the power storage system 31 in the vehicle 30, there is a higher possibility that the power storage system 31 (the battery 33) in the vehicle 30a belonging to the user A, who has a higher likelihood for plugging in than the user B, is connected to the charging/discharging equipment 4a.

Description is given regarding leeway for increasing DR (an increase in electric power demand) and leeway for reducing DR (a decrease in electric power demand), in a case where the charging/discharging equipment 4 is electrically connected the power storage system 31 in the vehicle 30. There is a tendency for the user A to have a higher SOC at a time of plugging in, compared to the user B. Accordingly, from the perspective of leeway for increasing DR, in comparison to the power storage system 31 in the vehicle 30a belonging to the user A, the power storage system 31 in the vehicle 30b that belongs to the user B and has a low SOC has a higher possibility of being able to absorb a greater amount of electric power from the electric power network 100 by charging and increasing the amount of demand. In contrast, from the perspective of leeway for reducing DR, the power storage system 31 in the vehicle 30a that belongs to the user A and has a high SOC has a higher possibility of having a greater amount of electric power that can be provided to the electric power network 100 by discharging, in comparison to the power storage system 31 in the vehicle 30b belonging to the user B.

Returning to FIG. 5, description is given regarding a process in step S12 that is executed after the obtainment process in step S11. In step S12, the priority level setting unit 22 sets a priority level for the power storage system 31 in the vehicle 30 that belongs to the user and is to be subject to DR control based on behavioral characteristics for the user. For example, the priority level setting unit 22 sets a high priority level to the power storage system 31 in the vehicle 30a belonging to the user A, who has indicated behavioral characteristics in which the frequency of charging the mobile terminal 40 is high. Preferential treatment (a reward) pertaining to points, money, a service, or the like is granted to a user for whom a high priority level has been set. The processing transitions to step S13 after the process in step S12.

In step S13, the notification unit 23 sets a notification frequency based on the behavioral characteristics for the user. For example, the notification unit 23 sets a relatively higher notification frequency for the user B, who has indicated behavioral characteristics for a low frequency of charging the mobile terminal 40b. The processing transitions to step S14 after the process in step S13.

In step S14, the demand prediction unit 24 obtains a demand prediction for electric power, based on various items of environment information. For example, the various items of environment information are, inter alia, information that pertains to weather information, time of year, air temperature, past records, and supply and demand for electric power, said information being for within the region for the electric power network 100. In addition to the various items of environment information, the demand prediction unit 24 in the present embodiment predicts demand by reflecting charge/discharge timings by the power storage system 31 that are estimated based on user behavioral characteristics. The usage history of the mobile terminal 40, which belongs to a user, functions as a parameter for calculating a demand prediction. The processing transitions to step S15 after the process in step S14.

In step S15, the selection unit 25 executes a selection process for selecting, from among a plurality of power storage systems 31, a power storage system 31 for transmitting or receiving power to or from the electric power network 100. Description is given below regarding an example of a selection process in the present embodiment.

In the selection process, the selection unit 25 estimates charging and discharging trends for the power storage system 31 in the vehicle 30 based on the information indicated by the usage history that is for the mobile terminal 40 belonging to the user and was obtained by the obtainment unit 21. For example, the selection unit 25 estimates a charge/discharge timing for the power storage system 31 in the vehicle 30a based on the behavioral characteristics for the user A, and estimates a charge/discharge timing for the power storage system 31 in the vehicle 30b based on the behavioral characteristics for the user B. This charge/discharge timing estimation is executed for each registered user.

Next, the selection unit 25 selects a power storage system 31 that is to be a target of DR control, based on the estimated charging and discharging trends. In a case where a supply/demand state indicates excess electric power, a power storage system 31 that is likely to have a low SOC such as with the power storage system 31 belonging to the user B is preferentially set as a target of DR control, and the power storage system 31 is charged to thereby absorb electric power. In a case where the supply/demand state indicates insufficient electric power, a power storage system 31 that is likely to have a high SOC such as with the power storage system 31 belonging to the user A is preferentially set as a target for DR control, and the power storage system 31 is discharged to thereby transmit electric power to electric power network 100.

In addition, the selection unit 25 generates an allocation proposal for the power storage system 31 that is a target of DR control, based on the demand prediction from the demand prediction unit 24, the information pertaining to electric power supply and demand obtained from the aggregator server 5, or both of these. The allocation proposal specifies a number of power storage systems 31 or a power storage system 31 that belongs to a user and is set as a target. As described above, the power storage system 31 that belongs to a user and is set in the allocation proposal changes in accordance with whether the state of electric power supply and demand is excess electric power or insufficient electric power. For example, the selection unit 25 creates an allocation proposal that, from among power storage systems 31 that have been selected, preferentially combines power storage systems 31 which have a high possibility of being connected to the charging/discharging equipment 4 (high DR likelihood) or for which a high priority level has been set. In this manner, the usage history, which is for the mobile terminal 40 belonging to a user, functions as a parameter for generating the allocation proposal.

Description is given regarding a process in step S16 that is executed after the selection process in step S15. In step S16, the notification unit 23 notifies a charge/discharge request to the power storage system 31 in the vehicle 30 selected as a target for DR control by the selection unit 25. It may be that the notification unit 23 makes a notification to the system control unit 32 in the power storage system 31, or makes a notification to the mobile terminal 40 belonging to a user. The processing transitions to step S17 after the process in step S16.

In step S17, the DR control execution unit 26 causes a target power storage system 31, for which there was a response to the notification from the notification unit 23, to execute charging or discharging. Alternatively, the DR control execution unit 26 executes DR if a condition for participation, such as plugin, is ready, and does not make a response indicating whether participation is approved to individual participation requests for each DR event, for example. By virtue of the series of processing from step S11 through step S17, DR control that reflects user behavioral characteristics is executed by the control apparatus 10. As a result, the plurality of batteries 33 mounted to a plurality of vehicles 30 provide an electric power resource to the electric power network 100.

As described above, the control apparatus 10 according to the present embodiment is provided with: the obtainment unit 21 that, for each of a plurality of power storage systems 31 respectively mounted to a plurality of vehicles 30, obtains a usage history of a mobile terminal 40 which corresponds to an external power storage apparatus associated with the power storage system 31; and the selection unit 25 that estimates trends for charging and discharging between each power storage system 31 and the electric power network 100 based on the usage history of the mobile terminal 40 and, in accordance with an estimation result, selects from the plurality of power storage systems 31 a power storage system 31 to be subject to charging or discharging from or to the electric power network 100.

As a result, it is possible to obtain behavioral characteristics, which pertain to charging and relate to a user, from the usage history of another device (an external power storage apparatus) that differs from the power storage system 31 in the vehicle 30, and use these behavioral characteristics to predict charging and discharging trends for the power storage system 31 in the vehicle 30. Accordingly, even if vehicle usage information that is for predicting charging and discharging trends for the power storage system 31 is not sufficient, it is possible to understand charging and discharging trends for the power storage system 31, and it is possible accurately select a power storage system 31 that is to be a target for DR control.

In addition, in the present embodiment, the external power storage apparatus is the mobile terminal 40 that is owned by the user of a vehicle 30.

As a result, it is possible to easily and accurately obtain behavioral characteristics pertaining to charging for the user from the mobile terminal 40, which is, inter alia, a smartphone or tablet that the user normally uses.

In addition, the control apparatus 10 according to the present embodiment is further provided with the priority level setting unit 22 that sets a high priority level for the power storage system 31 corresponding to the mobile terminal 40 in a case where the mobile terminal 40 has a high frequency of charging.

As a result, it is possible to use the priority level to manage, in a differentiated manner, users who have a high probability of the power storage system 31 being connected to the charging/discharging equipment 4, and have a high level of contribution to DR control. Accordingly, it is possible to preferentially select a power storage system 31 for which the user thereof has a high priority level, or grant points, services, or the like to a user who has a high priority level.

In addition, the control apparatus 10 according to the present embodiment is further provided with the notification unit 23 that sets a high frequency for notifying information pertaining to charging or discharging with respect to the power storage system 31 corresponding to the mobile terminal 40 in a case where there is a low frequency of charging for the mobile terminal 40.

As a result, it becomes easier for a user, who has a low probability that the charging/discharging equipment 4 and the power storage system 31 are connected, to recognize information pertaining to charging and discharging such as a charging/discharging request or the start of DR control, and the probability that the charging/discharging equipment 4 will be connected to the power storage system 31 increases. The responsiveness on the power storage system 31 side increases, and it is possible to further improve the effectiveness of DR control.

In addition, in the present embodiment, the selection unit 25 reflects, to the selection of the power storage system, timings for the maintenance of the state of charge of the mobile terminal 40, as well as an extent to which the state of charge of the mobile terminal 40 has been maintained.

As a result, it is possible to obtain more detailed behavioral characteristics pertaining to charging, such as timings for charging or a state-of-charge ratio for charging and discharging. Therefore, it is possible to predict more accurate charging and discharging trends for the power storage system 31.

In addition, in the present embodiment, the obtainment unit 21 obtains, as usage history, information that includes at least a charging history, at timings at which the mobile terminal 40 is charged within the vehicle 30.

As a result, it is possible to reliably and easily obtain user behavioral characteristics that pertain to charging at timings when the mobile terminal 40 is charged in the vehicle 30. In addition, the control apparatus 10 understands that the vehicle 30 is being ridden to thereby be able to send a notification that requests charging or discharging to the user at a timing when they disembark the vehicle 30. A time of disembarking is a timing at which it would be easy to connect the charging/discharging equipment 4 with the power storage system 31 in the vehicle 30, and it is possible to effectively prompt charging or discharging to the user.

In addition, in the present embodiment, the obtainment unit 21 obtains a usage history at a time of charging by the non-contact charging apparatus 35 within the vehicle 30.

As a result, it is possible to increase timings for obtaining usage history in accordance with non-contact supply of power that is easy for a user to use, and it is possible to more accurately estimate charging and discharging trends for the power storage system 31. A usage history of a driver who has a high probability of performing a task to charge the power storage system 31 is obtained, whereby it is possible to more accurately predict charging and discharging trends for the power storage system 31.

In addition, in the present embodiment, the selection unit 25 preferentially selects a power storage system 31 that has a high probability of being connected to the charging/discharging equipment 4.

As a result, the power storage system 31 selected by the selection unit 25 has a high probability of being connected to the charging/discharging equipment 4, and thus it is possible to more effectively realize DR control.

In addition, in the present embodiment, in a case where the supply/demand state of the electric power network 100 indicates excess electric power, the selection unit 25 preferentially selects a power storage system 31 for a user who indicates a tendency for having a low state of charge based on the usage history.

As a result, a power storage system 31 that can consume (be charged by) a greater amount of electric power due to having a low state of charge is selected as a target of DR control. Therefore, it is possible to increase tolerance for a time of DR control, and it is possible to carry out a more stable adjustment of supply and demand.

In addition, in the present embodiment, in a case where the supply/demand state of the electric power network 100 indicates insufficient electric power, the selection unit 25 preferentially selects a power storage system 31 for a user who indicates a tendency for having a high state of charge based on the usage history.

As a result, a power storage system 31 that can provide (discharge) more electric power due to having a high state of charge is selected as a target of DR control at a time of insufficient electric power, and therefore it is possible to carry out a more stable adjustment of supply and demand.

In addition, in the present embodiment, the selection unit 25 generates an allocation proposal that indicates a combination of power storage systems 31 selected as a power storage system 31 for carrying out charging or discharging from or to the electric power network 100 and, in this allocation proposal, power storage systems are selected by employing a priority level that is set based on charging and discharging trends as a parameter.

As a result, it is possible to use the behavioral characteristics pertaining to charging by users to accurately select a combination of power storage systems 31, which are selected from among a plurality of power storage systems 31 present within the region for electric power network 100.

In addition to, the control apparatus 10 according to the present embodiment is provided with: the obtainment unit 21 that, for each of a plurality of power storage system 31 respectively mounted to a plurality of vehicles 30, obtains a usage history of a mobile terminal 40 which corresponds to an external power storage apparatus associated with the power storage system 31; and the demand prediction unit 24 that obtains a demand prediction for an electric power network, and reflects charging and discharging trends, which are between the power storage system 31 and the electric power network 100 and are estimated based on the usage history of the mobile terminal 40, to the demand prediction.

As a result, it is possible to obtain behavioral characteristics, which pertain to charging and relate to a user, from the usage history of another device (an external power storage apparatus) that differs from the power storage system 31 in the vehicle 30, and use these behavioral characteristics to predict charging and discharging trends for the power storage system 31 in the vehicle 30. Accordingly, even in a case where usage information for a vehicle is not sufficient to predict charging and discharging trends for the power storage system 31, it is possible to understand charging and discharging trends for the power storage system 31 and it is possible to accurately predict demand for electric power within the region for the electric power network 100.

A series of processing described above can be executed by hardware, and can also be executed by software. In other words, functional configurations described above are merely examples, and there is no particular limitation thereto. In other words, it is sufficient if a computer is provided with functionality that can execute the series of processing described above as a whole, and which functional block to use in order to realize this functionality is not limited in particular to the examples described above. In addition, locations where functional blocks are present are not limited in particular, and may be discretionary. For example, it may be that one functional block is configured by a single unit of hardware, is configured by a single unit of software, or is configured by a combination of these. In a case of using software to cause the execution of the series of processing, a program that configures said software is installed onto a computer or the like from a network or a recording medium. The computer may be incorporated in dedicated hardware. In addition, it may be that the computer is installed with various types of program to enable the execution of various types of functionality, or is a server or a general-purpose smartphone or personal computer, for example.

A recording medium that includes such programs is configured by, inter alia, removable media (not illustrate) that is distributed separately from the body of an apparatus in order to provide the programs to a user or the like, or removable media that is provided to a user or the like in a state of having been incorporated in the body of the apparatus in advance. The programs can be distributed via a network. Therefore, it may be that the recording medium is mounted to or can be accessed by a computer that is connected to or can connect to the network. In addition, steps expressing a program recorded onto a recording medium include of course processing that is performed in a chronological order following the order of said steps, as well as processing that is separately executed in parallel and is not necessarily processed in chronological order.

### EXPLANATION OF REFERENCE NUMERALS

10 Control apparatus
21 Obtainment unit
22 Priority level setting unit
23 Notification unit
24 Demand prediction unit
25 Selection unit
30 Vehicle
31 Power storage system
40 Mobile terminal (external power storage apparatus)

What is claimed is:

1. A control apparatus, comprising:
an obtainer configured to obtain, for each power storage respectively mounted to a plurality of vehicles, a usage history of an external power storage associated with the power storage; and
a selector configured to estimate charging and discharging trends between each power storage and an electric power network based on the usage history of the external power storage and, in accordance with an estimation result, select from among a plurality of the power storages a power storage to be subject to charging or discharging from or to the electric power network.

2. The control apparatus according to claim 1, wherein
the external power storage is a mobile terminal owned by a user of the vehicle.

3. The control apparatus according to claim 1, further comprising:
a priority level setter configured to set a high priority level for the power storage corresponding to the external power storage in a case where there is a high frequency of charging for the external power storage.

4. The control apparatus according to claim 1, further comprising:
a notifier configured to set a high frequency for notifying information pertaining to charging or discharging with respect to the power storage corresponding to the external power storage in a case where there is a low frequency of charging for the external power storage.

5. The control apparatus according to claim 1, wherein
the selector reflects, to the selection of the power storage, timing for maintenance of a state of charge of the external power storage, as well as an extent to which the state of charge of the external power storage has been maintained.

6. The control apparatus according to claim 1, wherein
at a timing when the external power storage is charged within the vehicle, the obtainer obtains, as the usage history, information that includes at least a charging history.

7. The control apparatus according to claim 6, wherein
the obtainer obtains the usage history at a time of charging using a non-contact charger that is within the vehicle.

8. The control apparatus according to claim 1, wherein
the selector preferentially selects the power storage that has a high probability of being connected to a charger/discharger.

9. The control apparatus according to claim 1, wherein
in a case where a supply/demand state of the electric power network indicates excess electric power, the selector preferentially selects the power storage belonging to a user indicating a tendency to have a low state of charge based on the usage history.

10. The control apparatus according to claim 1, wherein
in a case where a supply/demand state of the electric power network indicates insufficient electric power, the selector preferentially selects, based on the usage history, the power storage that belongs to a user and indicates a trend for a high state of charge.

11. The control apparatus according to claim 1, wherein
the selector generates an allocation proposal that indicates a combination of the power storages selected to be the power storage for carrying out charging or discharging from or to the electric power network, and
in the allocation proposal, the power storages are selected by employing a priority level set based on the charging and discharging trends as a parameter.

12. A control apparatus, comprising:
an obtainer configured to obtain, for each power storage respectively mounted to a plurality of vehicles, a usage history of an external power storage associated with the power storage; and
a demand predictor that obtains a demand prediction for an electric power network and reflects, to the demand prediction, charging and discharging trends that are for between the electric power network and the power storage and are estimated based on the usage history of the external power storage.
